(19) United States
(12) Patent Application Publication
(10) Pub. No.: US 2025/0282347 A1
(43) Pub. Date: Sep. 11, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/059,594

(22) Filed: Feb. 21, 2025

(30) Foreign Application Priority Data
Mar. 8, 2024 (JP) 2024-035560

(51) Int. Cl. B60W 30/09; B60W 10/20; B60W 40/04

(52) U.S. Cl. CPC B60W 30/09; B60W 10/20; B60W 40/04; B60W 2552/10; B60W 2552/53; B60W 2554/4041; B60W 2554/4044; B60W 2556/40; B60W 2710/20; B60W 2720/10

(57) ABSTRACT

A vehicle control device includes: a first recognizer configured to recognize a first marking line defining a traveling lane of a host vehicle and a surrounding situation including a neighboring vehicle; a second recognizer configured to recognize a second marking line defining a lane near the host vehicle from map information; a driving controller configured to perform driving control. An intermediate direction between an extending direction of the other of the first marking line and the second marking line and a longitudinal direction of a vehicle body of the neighboring vehicle is estimated as a moving direction of the neighboring vehicle, and a time which the neighboring vehicle is to take to depart from one marking line is calculated when the neighboring vehicle moves in the estimated moving direction. The driving control continues to be performed when the calculated time is equal to or greater than a threshold value.

### CROSS-REFERENCE TO RELATED APPLICATION

Priority is claimed on Japanese Patent Application No. 2024-035560, filed Mar. 8, 2024, the content of which is incorporated herein by reference.

### BACKGROUND

### Field of the Invention

The present invention relates to a vehicle control device, a vehicle control method, and a storage medium.

### Description of Related Art

Recently, countermeasures for providing access to a sustainable transportation system in which vulnerable persons out of traffic participants are considered have been actively studied. In order to realize such countermeasures, focus has been concentrated on research and development for further improving safety or convenience of traffic through research and development on automated driving technology. In this regard, a technique of controlling a driving mode of a vehicle on the basis of parallelism between a traveling trajectory of another vehicle near the vehicle and a road marking line appearing in a camera image when it is determined that there is separation between the road marking line appearing in the camera image and a road marking line included in map information has been recently disclosed (for example, Japanese Unexamined Patent Application, First Publication No. 2023-148405).

### SUMMARY

In such automated driving technology according to the related art, when a road marking line indicated by a camera image and a road marking line indicated by map information are separated, there is room for studying driving control when an extending direction of the road marking line changes or when a position of another vehicle is considered.

In order to solve the aforementioned problem, an objective of the present invention is to provide a vehicle control device, a vehicle control method, and a storage medium that can perform more appropriate driving control according to road marking lines near a vehicle and a situation of another vehicle. Another objective thereof is to contribute to advancement of a sustainable transportation system.

A vehicle control device, a vehicle control method, and a storage medium according to the present invention employ the following configurations.

(1) According to an aspect of the present invention, there is provided a vehicle control device including: a first recognizer configured to recognize a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; a second recognizer configured to recognize a second marking line defining a lane near the host vehicle from map information on the basis of position information of the host vehicle; a driving controller configured to perform driving control for controlling at least steering of steering and a speed of the host vehicle on the basis of recognition results from the first recognizer and the second recognizer; and a traveling trajectory estimator configured to estimate a traveling trajectory of the neighboring vehicle, wherein the driving controller performs the driving control on the basis of one of the first marking line and the second marking line when the first marking line and the second marking line are separated, the traveling trajectory estimator estimates an intermediate direction between an extending direction of the other of the first marking line and the second marking line and a longitudinal direction of a vehicle body of the neighboring vehicle as a moving direction of the neighboring vehicle when the first marking line and the second marking line are separated and calculates a time which the neighboring vehicle is to take to depart from one of the first marking line and the second marking line when the neighboring vehicle moves in the estimated moving direction, and the driving controller continues to perform the driving control when the time is equal to or greater than a threshold value.

(2) According to another aspect of the present invention, there is provided a vehicle control device including: a first recognizer configured to recognize a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; a second recognizer configured to recognize a second marking line defining a lane near the host vehicle from map information on the basis of position information of the host vehicle; a driving controller configured to perform driving control for controlling at least steering of steering and a speed of the host 5 vehicle on the basis of recognition results from the first recognizer and the second recognizer; and a traveling trajectory estimator configured to estimate a traveling trajectory of the neighboring vehicle, wherein the driving controller performs the driving control on the basis of one of the first marking line and the second marking line when the first marking line and the second marking line are separated, the traveling trajectory estimator estimates an intermediate direction between an extending direction of the other of the first marking line and the second marking line and a longitudinal direction of a vehicle body of the neighboring vehicle as a moving direction of the neighboring vehicle when the first marking line and the second marking line are separated and calculates a time which the host vehicle traveling under the driving control and the neighboring vehicle are to take to interfere with each other when the neighboring vehicle moves in the estimated moving direction, and the driving controller continues to perform the driving control when the time is equal to or greater than a threshold value.

(3) In the aspect of (1), the vehicle control device further includes a determiner configured to determine that one of the first marking line and the second marking line has been erroneously recognized when an obstacle is present in the traveling lane of the host vehicle.

(4) In the aspect of (1), the vehicle control device further includes a determiner configured to determine that one of the first marking line and the second marking line has been erroneously recognized when it is determined a first predetermined number of times or more that the time is less than a first threshold value and to determine that the other of the first marking line and the second marking line has been erroneously recognized when the number of times the time is less than a second threshold value greater than the first threshold value is equal to or greater than a second predetermined number of times larger than the first predetermined number of times.

(5) In the aspect of (1), the traveling trajectory estimator estimates an intermediate position between the extending direction of the other of the first marking line and the second marking line and the longitudinal direction of the vehicle body of the neighboring vehicle as a traveling direction of the neighboring vehicle.

(6) In the aspect of (1), the traveling trajectory estimator adjusts the intermediate direction according to an amount of deviation between the first marking line and the second marking line when the neighboring vehicle is estimated to be traveling in the intermediate direction between the extending direction of the other of the first marking line and the second marking line and the longitudinal direction of the vehicle body of the neighboring vehicle.

(7) In the aspect of (1), the vehicle control device further includes a determiner configured to determine whether the first marking line has been erroneously recognized on the basis of at least one of a change in curvature of the first marking line and an angle formed by the first marking line and the second marking line when it is determined whether the first marking line and the second marking line are separated and to perform the determination of erroneous recognition when a changing direction of the change in curvature and a changing direction of the angle are the same and the change in curvature and the angle increase according to a distance from the host vehicle.

(8) According to another aspect of the present invention, there is provided a vehicle control method that is performed by a computer, the vehicle control method including: recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; recognizing a second marking line defining a lane near the host vehicle from map information on the basis of position information of the host vehicle; performing driving control for controlling at least steering of steering and a speed of the host vehicle on the basis of recognition results; estimating a traveling trajectory of the neighboring vehicle; performing the driving control on the basis of one of the first marking line and the second marking line when the first marking line and the second marking line are separated; estimating an intermediate direction between an extending direction of the other of the first marking line and the second marking line and a longitudinal direction of a vehicle body of the neighboring vehicle as a moving direction of the neighboring vehicle when the first marking line and the second marking line are separated; calculating a time which the neighboring vehicle is to take to depart from one of the first marking line and the second marking line when the neighboring vehicle moves in the estimated moving direction; and continuing to perform the driving control when the time is equal to or greater than a threshold value.

(9) According to another aspect of the present invention, there is provided a vehicle control method that is performed by a computer, the vehicle control method including: recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; recognizing a second marking line defining a lane near the host vehicle from map information on the basis of position information of the host vehicle; performing driving control for controlling at least steering of steering and a speed of the host vehicle on the basis of recognition results; estimating a traveling trajectory of the neighboring vehicle; performing the driving control on the basis of one of the first marking line and the second marking line when the first marking line and the second marking line are separated; estimating an intermediate direction between an extending direction of the other of the first marking line and the second marking line and a longitudinal direction of a vehicle body of the neighboring vehicle as a moving direction of the neighboring vehicle when the first marking line and the second marking line are separated; calculating a time which the host vehicle traveling under the driving control and the neighboring vehicle are to take to interfere with each other when the neighboring vehicle moves in the estimated moving direction; and continuing to perform the driving control when the time is equal to or greater than a threshold value.

(10) According to another aspect of the present invention, there is provided a non-transitory computer-readable storage medium storing a program, the program causing a computer to perform: recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; recognizing a second marking line defining a lane near the host vehicle from map information on the basis of position information of the host vehicle; performing driving control for controlling at least steering of steering and a speed of the host vehicle on the basis of recognition results; estimating a traveling trajectory of the neighboring vehicle; performing the driving control on the basis of one of the first marking line and the second marking line when the first marking line and the second marking line are separated; estimating an intermediate direction between an extending direction of the other of the first marking line and the second marking line and a longitudinal direction of a vehicle body of the neighboring vehicle as a moving direction of the neighboring vehicle when the first marking line and the second marking line are separated; calculating a time which the neighboring vehicle is to take to depart from one of the first marking line and the second marking line when the neighboring vehicle moves in the estimated moving direction; and continuing to perform the driving control when the time is equal to or greater than a threshold value.

(11) According to another aspect of the present invention, there is provided a non-transitory computer-readable storage medium storing a program, the program causing a computer to perform: recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle; recognizing a second marking line defining a lane near the host vehicle from map information on the basis of position information of the host vehicle; performing driving control for controlling at least steering of steering and a speed of the host vehicle on the basis of recognition results; estimating a traveling trajectory of the neighboring vehicle; performing the driving control on the basis of one of the first marking line and the second marking line when the first marking line and the second marking line are separated; estimating an intermediate direction between an extending direction of the other of the first marking line and the second marking line and a longitudinal direction of a vehicle body of the neighboring vehicle as a moving direction of the neighboring vehicle when the first marking line and the second marking line are separated; calculating a time which the host vehicle traveling under the driving control and the neighboring vehicle are to take to interfere with each other when the neighboring vehicle moves in the estimated moving direction; and continuing to perform the driving control when the time is equal to or greater than a threshold value.

According to the aspects of (1) to (11), it is possible to perform more appropriate driving control according to road marking lines near a vehicle and a situation of another vehicle.

### BRIEF DESCRIPTION OF THE DRAWINGS

FIG. 1 is a diagram illustrating a configuration of a vehicle system including a vehicle control device according to an embodiment.

FIG. 2 is a diagram illustrating functional configurations of a first controller and a second controller.

FIG. 3 is a diagram illustrating driving control of a host vehicle M in a first situation.

FIG. 4 is a diagram illustrating separation determination based on a change in curvature when a lane is a curved lane.

FIG. 5 is a diagram illustrating driving control of the host vehicle M in a second situation.

FIG. 6 is a flowchart illustrating an example of a flow of a driving control process according to a first example.

FIG. 7 is a flowchart illustrating an example of a flow of a driving control process according to a second example.

### DESCRIPTION OF EMBODIMENTS

Hereinafter, a vehicle control device, a vehicle control method, and a storage medium according to an embodiment of the present invention will be described with reference to the accompanying drawings. In the following embodiment, for example, a vehicle control device is applied to an automated-driving vehicle. Automated driving is, for example, to perform driving control by automatically controlling one or both of steering and a speed of a vehicle. The driving control may include, for example, driving control such as adaptive cruise control system (ACC), traffic jam pilot (TJP), lane keeping assistance system (LKAS), automated lane change (ALC), and collision mitigation brake system (CMBS). In an automated-driving vehicle, driving control (so-called manual driving) based on a manual operation of a user (for example, an occupant) of a vehicle may be performed. In the following description, left-hand traffic regulations are applied, but left and right can be exchanged when right-hand traffic regulations are applied.

### [Entire Configuration]

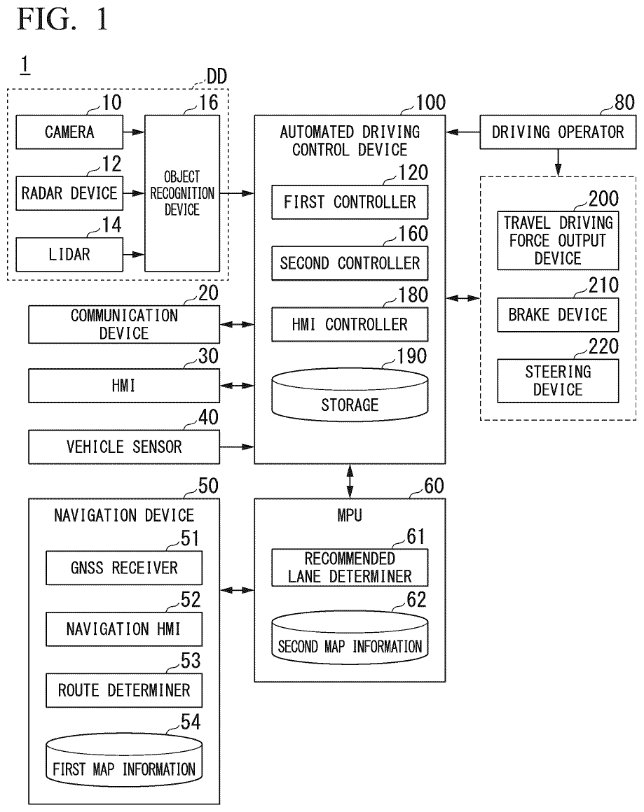

FIG. 1 is a diagram illustrating a configuration of a vehicle system 1 including a vehicle control device according to an embodiment. A vehicle (hereinafter referred to as a host vehicle M) in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a battery (a storage battery) such as a secondary battery or a fuel cell.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto. A combination of the camera 10, the radar device 12, the LIDAR device 14, and the object recognition device 16 is an example of a “detection device DD.” The HMI 30 is an example of an “output device.” The automated driving control device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on the host vehicle M in which the vehicle system 1 is mounted. When a forward view is imaged, the camera 10 is attached to an upper part of a front windshield, a rear surface of a rearview mirror, a front head part of a vehicle body, or the like. When a rearward view is imaged, the camera 10 is attached to an upper part of a rear windshield, a back door, or the like. When a side view is imaged, the camera 10 is attached to a door mirror or the like. The camera 10 images the surroundings of the host vehicle M, for example, periodically and repeatedly. The camera 10 may be a stereo camera.

The radar device 12 radiates radio waves such as millimeter waves to the surroundings of the host vehicle M, detects radio waves (reflected waves) reflected by a nearby object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR device 14 radiates light to the surroundings of the host vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the host vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the automated driving control device 100. The object recognition device 16 may output the results of detection from the camera 10, the radar device 12, and the LIDAR device 14 to the automated driving control device 100 without any change. In this case, the object recognition device 16 may be omitted from the vehicle system (the detection device DD).

The communication device 20 communicates with other vehicles near the host vehicle M, a terminal device of a user of the host vehicle M, or various server devices, for example, using a network such as a cellular network, a Wi-Fi network, Bluetooth (registered trademark), dedicated short range communication (DSRC), a local area network (LAN), a wide area network (WAN), or the Internet.

The HMI 30 presents various types of information to an occupant of the host vehicle M and receives an input operation from the occupant. The HMI 30 includes, for example, various types of display devices, a speaker, a buzzer, a touch panel, a switch, keys, and a microphone.

The vehicle sensor 40 includes a vehicle speed sensor that detects a speed of the host vehicle M, an acceleration sensor that detects acceleration, a yaw rate sensor that detects a yaw rate (for example, an angular velocity around a vertical axis passing through the center of gravity of the host vehicle M), and a direction sensor that detects a direction of the host vehicle M. The vehicle sensor 40 may include a position sensor that detects a position of the host vehicle M. The position sensor is an example of a “position measuring unit.” The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50. The vehicle sensor 40 may derive the speed of the host vehicle M from a difference in position information (that is, a distance) at a predetermined time in the position sensor. The result detected by the vehicle sensor 40 is output to the automated driving control device 100.

The navigation device 50 includes, for example, a GNSS receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or corrected by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or wholly shared by the HMI 30. For example, the route determiner 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include point of interest (POI) information. The route on a map is output to the MPU 60. The navigation device 50 may perform route guidance using the navigation HMI 52 on the basis of the route on a map. The navigation device 50 may transmit a current position and a destination to a navigation server via the communication device 20 and acquire a route which is equivalent to the route on a map from the navigation server. The navigation device 50 outputs the determined route on a map to the MPU 60.

The MPU 60 includes, for example, a recommended lane determiner 61 and stores second map information 62 in a storage device such as an HDD or a flash memory. The recommended lane determiner 61 divides the route on a map provided from the navigation device 50 into a plurality of blocks (for example, blocks every 100 [m] in a vehicle traveling direction) and determines a recommended lane for each block with reference to the second map information 62. The recommended lane determiner 61 determines in which lane from the leftmost the host vehicle M is to travel. When there is a branching point in the route on a map, the recommended lane determiner 61 determines the recommended lane such that the host vehicle M can travel along a rational route for traveling to a branching destination.

The second map information 62 is map information with higher precision than the first map information 54. For example, the second map information 62 includes, for example, information of the number of lanes, types or shapes of road marking lines (hereinafter referred to as marking lines), and lane centers or information of road boundaries. The second map information 62 may include information indicating whether a road boundary is a boundary including a structure through which a vehicle cannot pass (cross or contact). Examples of the structure include guardrails, curbstones, median strips, and fences. The structure through which a vehicle cannot pass may include a low step through which a vehicle can pass as long as vibration of the vehicle which will not normally occur is permitted. The second map information 62 may include road shape information, traffic regulation information, address information (addresses and postal codes), facility information, parking lot information, and phone number information. The road shape information may be replaced with, for example, a curvature (which may be replaced with a radius of curvature, which is the same in the following description), a width, and a gradient of a road. The second map information 62 may be updated from time to time by causing the communication device 20 to communicate with an external device. The first map information 54 and the second map information 62 may be provided as unified map information. The map information may be stored in a storage 190.

The driving operator 80 includes, for example, a steering wheel, an accelerator pedal, and a brake pedal. The driving operator 80 may include a shift lever, a deformed steering wheel, a joystick, and other operators. For example, an operation detector that detects an amount of operation on an operator by an occupant or performing of an operation is attached to each operator of the driving operator 80. The operation detector detects, for example, a steering angle or a steering torque of the steering wheel and an amount of depression of the accelerator pedal or the brake pedal. The operation detector outputs results of detection to the automated driving control device 100 or output to some or all of the travel driving force output device 200, the brake device 210, and the steering device 220.

The automated driving control device 100 performs various types of driving control belonging to automated driving on the host vehicle M. The automated driving control device 100 includes, for example, a first controller 120, a second controller 160, an HMI controller 180, and a storage 190. The first controller 120, the second controller 160, and the HMI controller 180 are realized, for example, by causing a hardware processor such as a central processing unit (CPU) to execute a program (software). Some or all of these constituents may be realized by hardware (a circuit unit including circuitry) such as a large scale integration (LSI) circuit, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the automated driving control device 100 in advance, or may be stored in a removable storage medium such as a DVD, a CD-ROM, or a memory card and installed in a storage device of the automated driving control device 100 by setting the storage medium (non-transitory storage medium) into a drive device or a card slot.

The storage 190 may be realized by the aforementioned various storage devices or an electrically erasable programmable read only memory (EEPROM), a read only memory (ROM), a random access memory (RAM), or the like. For example, various types of information and programs in the embodiment are stored in the storage 190. Map information (for example, the first map information 54 and the second map information 62) may be stored in the storage 190.

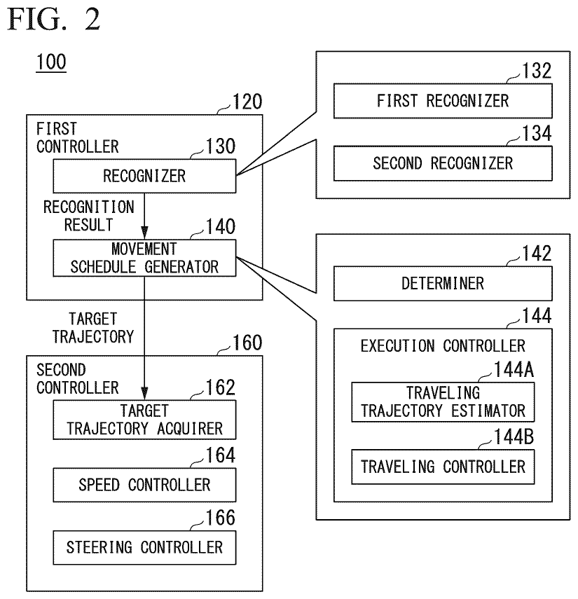

FIG. 2 is a diagram illustrating functional configurations of the first controller 120 and the second controller 160. The first controller 120 includes, for example, a recognizer 130 and a movement schedule generator 140. For example, the first controller 120 is realized using a function based on artificial intelligence (AI) and a function based on a predetermined model together. For example, a function of “recognizing a crossing” may be realized by performing recognition of a crossing based on deep learning or the like and recognition based on predetermined conditions (such as signals and road signs which can be pattern-matched) together, scoring both recognitions, and comprehensively evaluating the recognitions. Accordingly, reliability of automated driving is secured. The first controller 120 performs control associated with automated driving of the host vehicle M, for example, on the basis of instructions from the MPU 60 or the HMI controller 180.

The recognizer 130 recognizes a surrounding situation of the host vehicle M on the basis of the result of recognition from the detection device DD (information input from the camera 10, the radar device 12, and the LIDAR device 14 via the object recognition device 16). For example, the recognizer 130 recognizes states such as a position, a speed, and an acceleration of an object near the host vehicle M (within a predetermined distance from the host vehicle M). Examples of the object include another vehicle (a nearby vehicle), a traffic participant (such as a pedestrian or a bicycle) passing on a road, a road structure, and an object such as a nearby obstacle. Examples of the road structure include a road marking, a traffic signal, a crossing, a curbstone, a median strip, a guard rail, and a fence. For example, a position of an object is recognized as a position in an absolute coordinate system with a representative point (such as the center of gravity or the center of a drive shaft) of the host vehicle M as an origin and is used for control. A position of an object may be expressed as a representative point such as the center of gravity or a corner of the object or may be expressed as an area. For example, when an object is a mobile object such as another vehicle, a “state” of an object may include an acceleration or a jerk of the mobile object or a “moving state” (for example, whether the other vehicle is performing lane change or whether the other vehicle is going to perform lane change) thereof.

The recognizer 130 includes, for example, a first recognizer 132 and a second recognizer 134. Details of these functions will be described later.

The movement schedule generator 140 generates a movement schedule in which the host vehicle M will travel through automated driving on the basis of the result of recognition from the recognizer 130. For example, the movement schedule generator 140 generates a target trajectory in which the host vehicle M will travel autonomously (without requiring a driver's operation) in the future such that the host vehicle M can travel in a recommended lane determined by the recommended lane determiner 61 in principle and cope with a surrounding situation of the host vehicle M on the basis of a surrounding road shape or the like based on the current position of the host vehicle M acquired from the recognition result from the recognizer 130 or the map information. The target trajectory includes, for example, a speed element. For example, the target trajectory is expressed by sequentially arranging points (trajectory points) at which the host vehicle M is to arrive. Trajectory points are points at which the host vehicle M is to arrive at intervals of a predetermined traveling distance (for example, about several [m]) along a road, and a target speed and a target acceleration at every interval of a predetermined sampling time (for example, below the decimal point [sec]) are generated as a part of the target trajectory in addition thereto. The trajectory points may be positions at which the host vehicle M is to arrive at sampling times every predetermined sampling time. In this case, information of the target speed or the target acceleration is expressed by intervals between the trajectory points.

The movement schedule generator 140 may set events of automated driving in generating a target trajectory. The events of automated driving include, for example, a constant-speed traveling event in which the host vehicle M travels in the same lane at a constant speed, a following traveling event in which the host vehicle M travels to follow another vehicle which is present within a predetermined distance (for example, 100 [m]) in front of the host vehicle M and closest to the host vehicle M, a lane change event in which the host vehicle M changes a traveling lane to a neighboring lane, a branching event in which the host vehicle M travels to branch at a branching point of a road to a destination lane, a merging event in which the host vehicle M merges into a main road at a merging point, and a take-over event in which automated driving ends and is switched to manual driving. The events of automated driving may include, for example, an overtake event in which the host vehicle M changes the traveling lane to a neighboring lane, overtakes a preceding vehicle in the neighboring lane, and then changes the traveling lane to the original lane again and an avoidance event in which the host vehicle M is caused to perform at least one of braking and steering to avoid an obstacle in front of the host vehicle M.

The movement schedule generator 140 may change an event determined already for a current section to another event or set a new event for the current section, for example, on the basis of the surrounding situation of the host vehicle M recognized at the time of traveling of the host vehicle M. The movement schedule generator 140 may change an event determined already for a current section to another event or set a new event for the current section in response to an operation performed on the HMI 30 by an occupant. The movement schedule generator 140 generates a target trajectory based on the set event.

The movement schedule generator 140 includes, for example, a determiner 142 and an execution controller 144. Details of these functions will be described later.

The second controller 160 controls the travel driving force output device 200, the brake device 210, and the steering device 220 such that the host vehicle M travels along the target trajectory generated by the movement schedule generator 140 as scheduled.

The second controller 160 includes, for example, a target trajectory acquirer 162, a speed controller 164, and a steering controller 166. The target trajectory acquirer 162 acquires information of the target trajectory (trajectory points) generated by the movement schedule generator 140 and stores the acquired information in a memory (not illustrated). The speed controller 164 controls the travel driving force output device 200 or the brake device 210 on the basis of a speed element accessory to the target trajectory stored in the memory. The steering controller 166 controls the steering device 220 on the basis of a curved state of the target trajectory stored in the memory. The processes of the speed controller 164 and the steering controller 166 are realized, for example, by feed-forward control and feedback control in combination. For example, the steering controller 166 performs control in combination of feed-forward control based on a curvature of a road in front of the host vehicle M and feedback control based on a separation from the target trajectory.

Referring back to FIG. 1, the HMI controller 180 notifies an occupant of predetermined information using the HMI 30. The predetermined information includes, for example, information associated with traveling of the host vehicle M such as information on the state of the host vehicle M or information on driving control. The information on the state of the host vehicle M includes, for example, a speed, an engine rotation speed, and a shift position of the host vehicle M. The information on driving control includes, for example, information on an inquiry about whether driving control based on automated driving is to be performed or whether automated driving is to be started, information on a driving control situation based on automated driving, information on an automation level, and information for prompting an occupant to perform manual driving when automated driving is switched to manual driving. The predetermined information may include information not associated with traveling of the host vehicle M such as television programs and content (for example, movies) stored in a storage medium such as a DVD. The predetermined information may include, for example, a current position or a destination of the host vehicle M in automated driving and information on an amount of fuel remaining in the host vehicle M. The HMI controller 180 may output information received by the HMI 30 to the communication device 20, the navigation device 50, the first controller 120, and the like.

The HMI controller 180 may cause the HMI 30 to output the information on an inquiry of an occupant or process results from the first controller 120 and the second controller 160. The HMI controller 180 may transmit various types of information output from the HMI 30 to a terminal device used by a user of the host vehicle M via the communication device 20.

The travel driving force output device 200 outputs a travel driving force (a torque) for allowing the vehicle to travel to driving wheels. The travel driving force output device 200 includes, for example, a combination of an internal combustion engine, an electric motor, and a transmission and an electronic control unit (ECU) that controls them. The ECU controls these constituents on the basis of information input from the second controller 160 or information input from the accelerator pedal of the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or information input from the brake pedal of the driving operator 80 such that a brake torque based on a braking operation is output to vehicle wheels. The brake device 210 may include a mechanism for transmitting a hydraulic pressure generated by an operation on the brake pedal to the cylinder via a master cylinder as a backup. The brake device 210 is not limited to the above-mentioned configuration and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the steering wheel of the driving operator 80 to change the direction of the turning wheels.

### [Recognizer and Movement Schedule Generator]

Details of the functions of the recognizer 130 (the first recognizer 132 and the second recognizer 134) and the movement schedule generator 140 (the determiner 142 and the execution controller 144) will be described below. In the following description, details of driving control (traveling control) of the host vehicle M according to the embodiment will be mainly described divisionally in several situations.

### [First Situation]

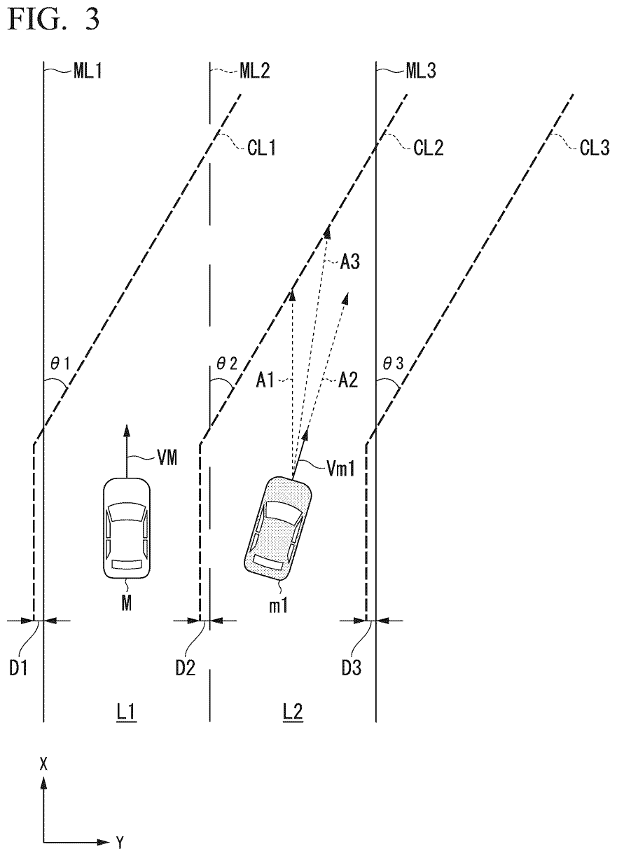

FIG. 3 is a diagram illustrating driving control of the host vehicle M in a first situation. In the example illustrated in FIG. 3, marking lines CL1 to CL3 recognized by the detection device DD and marking lines ML1 to ML3 acquired from map information (for example, the second map information 62) on the basis of the position information of the host vehicle M are illustrated. In the map information, a lane L1 is defined by the marking lines ML1 and ML2, and a lane L2 is defined by the marking lines ML2 and ML3. The lanes L1 and L2 are lanes extending in the same direction (in an X-axis direction in the drawing). In the example illustrated in FIG. 3, the marking lines CL1 to CL3 are an example of a “first marking line,” and the marking lines ML1 to ML3 are an example of a “second marking line.” In FIG. 3, it is assumed that the host vehicle M is traveling in the lane L1 at a speed VM and another vehicle m1 is traveling in the lane L2 which is adjacent to the lane L1 at a speed Vm1. The other vehicle m1 is a neighboring vehicle of (a vehicle traveling in parallel to) the host vehicle M. A neighboring vehicle is, for example, a vehicle which travels in a neighboring lane adjacent to a traveling lane of the host vehicle. A neighboring vehicle may be a vehicle which is present within a predetermined distance from the host vehicle M. In the example illustrated in FIG. 3, it is assumed that predetermined driving control (for example, LKAS) is performed on the host vehicle M on the basis of a surrounding situation, an instruction from an occupant, or the like.

The first recognizer 132 recognizes a surrounding situation of the host vehicle M on the basis of an output of the detection device DD having detected the surrounding situation (the outside) of the host vehicle M. For example, the first recognizer 132 recognizes left and right lane markings CL1 and CL2 defining the traveling lane (lane L1) of the host vehicle M on the basis of an image captured by the camera 10 (hereinafter referred to as a camera image). The first recognizer 132 may recognize the marking line CL3 defining the neighboring lane (lane L2) adjacent to the traveling lane. In the following description, the marking lines CL1 to CL3 may be referred to as “camera marking lines CL1 to CL3”). For example, the first recognizer 132 analyzes the camera image, extracts edge points with large differences in luminance from neighboring pixels in the image, and recognizes the camera marking lines CL1 to CL3 in an image plane by connecting the edge points. The first recognizer 132 converts positions of the camera marking lines CL1 to CL3 to a vehicle coordinate system (for example, the XY plane coordinate system in FIG. 3) with a position of a representative point of the host vehicle M as an origin. The first recognizer 132 may recognize, for example, curvatures of the camera marking lines CL1 to CL3. The first recognizer 132 may recognize changes in curvature of the camera marking lines CL1 to CL3. The changes in curvature are, for example, rates of change of curvature over time of the camera marking lines CL1 to CL3 recognized by the camera 10 at x [m] in front of the host vehicle M. The first recognizer 132 may recognize a curvature or a change in curvature of lines defined by the camera marking lines CL1 to CL3 by averaging the curvatures or the changes in curvature of the camera marking lines CL1 to CL3. The camera marking lines CL1 to CL3 may be recognized or corrected on the basis of an output from a detection device (for example, the radar device 12 or the LIDAR device 14) other than the camera 10.

The first recognizer 132 recognizes another vehicle which is present near the host vehicle M. In the example illustrated in FIG. 3, the first recognizer 132 recognizes the other vehicle m1 traveling in parallel with the host vehicle M in a neighboring lane. The first recognizer 132 recognizes a position (relative to the host vehicle M) or a speed (relative to the host vehicle M) of the other vehicle m1 or recognizes a traveling lane, a vehicle body direction, a traveling direction, and the like of the other vehicle m1. The first recognizer 132 recognizes a traveling position in the traveling lane of the other vehicle m1. The first recognizer 132 may recognize traveling position information of the other vehicle m1. The traveling position information is, for example, a traveling trajectory with respect to a position of a representative point of the other vehicle m1 at a predetermined timing at the time of traveling.

The second recognizer 134 recognizes, for example, marking lines of a lane near the host vehicle M from the map information on the basis of the position of the host vehicle M detected by the vehicle sensor 40 or the GNSS receiver 51. For example, the second recognizer 134 recognizes marking lines ML1 to ML3 which are preset in a traveling direction of the host vehicle M or in a direction in which the host vehicle M can travel with reference to the map information on the basis of the position information of the host vehicle M. In the following description, the marking lines ML1 to ML3 may be referred to as “map marking lines ML1 to ML3.”

The second recognizer 134 may recognize the map marking lines ML1 and ML2 which are marking lines defining the traveling lane of the host vehicle M out of the recognized map marking lines ML1 to ML3. The second recognizer 134 recognizes a curvature or a change in curvature of the map marking lines ML1 to ML3 from the second map information 62. The second recognizer 134 may recognize a curvature or a change in curvature of the lanes defined by the map marking lines by averaging the curvatures or the changes in curvature of the map marking lines ML1 to ML3.

The determiner 142 determines whether the camera marking lines CL1 to CL3 recognized by the first recognizer 132 are separated from the map marking lines ML1 to ML3 recognized by the second recognizer 134. For example, the determiner 142 derives a degree of separation between the marking lines CL1 and ML1 which are leftward closest to the host vehicle M, a degree of separation between the marking lines CL2 and ML2 which are rightward closest to the host vehicle M, and a degree of separation between the marking lines CL3 and ML3 on the neighboring lane side. Then, the determiner 142 determines that the camera marking lines are separated from the map marking lines when the derived degrees of separation are equal to or greater than threshold value and determines that both marking lines are not separated when the degrees of separation are less than the threshold value. Determination of whether they are separated is repeatedly performed at predetermined timings or at intervals of a predetermined period.

For example, the determiner 142 overlaps the camera marking lines CL1, CL2, and CL3 and the map marking lines ML1, ML2, and ML3 on a plane (an XY plane) of the vehicle coordinate system with the position of the representative point of the host vehicle M as a reference. When marking lines to be compared (marking lines CL1 and ML1, marking lines CL2 and ML2, and marking lines CL3 and ML3) are determined, the determiner 142 determines that the marking lines are separated when the degree of separation between the corresponding marking lines is equal to or greater than the threshold value and determines that the marking lines are not separated when the degree of separation between the corresponding marking lines is less than the threshold value. A degree of separation is, for example, an amount of deviation in lateral position (for example, the Y-axis direction in the drawing). In the example illustrated in FIG. 3, the separation determination may be performed using an average value of an amount of deviation in lateral position D1 between the marking lines CL1 and ML1, an amount of deviation in lateral position D2 between the marking lines CL2 and ML2, and an amount of deviation in lateral position D3 between the marking lines CL3 and ML3 or may be performed using a maximum value or a minimum value of the amounts of deviation D1, D2, and D3.

The degree of separation may be, for example, an amount (magnitude) of angle formed by two marking lines to be compared instead of (or in addition to) the amounts of deviation in lateral position. In the example illustrated in FIG. 3, an average value of an angle θ1 formed by the marking lines CL1 and ML1, an angle θ2 formed by the marking lines CL2 and ML2, and an angle θ3 formed by the marking lines CL3 and ML3 may be used, or a maximum value or a minimum value of the angles θ1, 02, and 03 may be used.

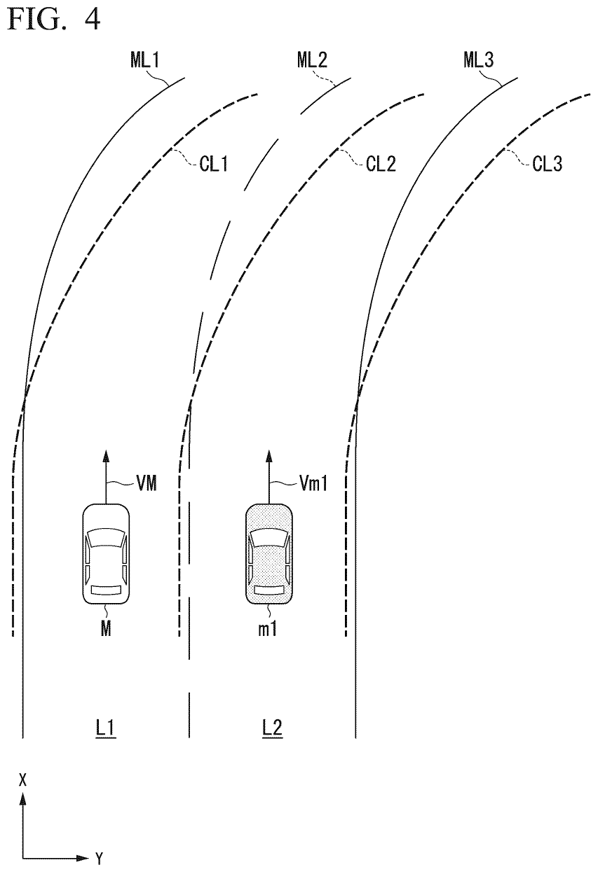

The degree of separation may be a degree (magnitude) of difference in a change in curvature between the marking lines instead of (or in addition to) the amounts of deviation in lateral position or the angles formed by the marking lines. A change in curvature is mainly used when the traveling lane is a curved road. FIG. 4 is a diagram illustrating the separation determination based on a change in curvature when a lane is a curved road. The example illustrated in FIG. 4 is different from the example illustrated in FIG. 3, in that the lanes L1 and L2 are curved roads and the camera marking lines and the map marking lines have predetermined curvatures.

In the example illustrated in FIG. 4, the first recognizer 132 recognizes the changes in curvature of the camera marking lines CL1 to CL3 on the basis of the output of the detection device DD. The second recognizer 134 recognizes the changes in curvature of the map marking lines ML1 to ML3 on the basis of the map information. Then, the determiner 142 may use an average value of a difference of the change in curvature between the marking lines CL1 and ML1, a difference of the change in curvature between the marking lines CL2 and ML2, and a difference of the change in curvature between the marking lines CL3 and ML3 or may use a maximum value or a minimum value of the differences. The determiner 142 may use a difference between the average value of the changes in curvature of the marking lines CL1 to CL3 and the average value of the changes in curvature of the marking lines ML1 to ML3. A difference between the changes in curvature between the lanes (lanes L1 and L2) recognized by the camera image and a difference between the changes in curvature of the lanes recognized from the map information may be used.

For example, when it is determined whether the camera marking lines and the map marking lines are separated, the determiner 142 may determine whether the camera marking lines have been erroneously recognized on the basis of one or both of the change in curvature of the camera marking lines detected by the recognizer 130 and the angle formed by the camera marking lines and the map marking lines. In this case, for example, when a changing direction of the change in curvature and a changing direction of the angle are the same and the change in curvature and the angle increase with an increase in a distance from the host vehicle M, the determiner 142 determines whether the camera marking lines have been erroneously recognized. In the embodiment, for example, when the change in curvature is equal to or greater than a first predetermined value, the angle is equal to or greater than a second predetermined value, and at least one thereof trends to decrease, there is a likelihood that erroneous recognition due to a curved road or the like will converge, and thus the determiner 142 determines that the camera marking lines have not been erroneously recognized. On the other hand, when both of the change in curvature and the angle increase in the same direction and become equal to or greater than predetermined values, the determiner 142 determines that the camera marking lines have been erroneously recognized. Accordingly, since erroneous recognition is determined when both of the change in curvature and the angle increase, it is possible to exclude a case in which both decrease and trend to converge and to more accurately determine whether the camera marking lines have been erroneously recognized when the host vehicle travels in a lane change section such as a curved road.

The execution controller 144 determines driving control for the host vehicle M on the basis of the determination result from the determiner 142 and performs the determined driving control. “Determining driving control” may include, for example, determining details (types) of the driving control or determining whether driving control is to be performed (or to be curbed). “Performing driving control” may include, for example, continuing to perform driving control in execution in addition to switching and performing details of driving control. “Curbing driving control” may include lowering an automation level of driving control and ending driving control in addition to not performing driving control. The driving control which is performed by the execution controller 144 may include ACC, TJP, LKAS, ALC, and CMBS and may include various types of driving control for avoiding collision with a neighboring vehicle. The execution controller 144 generates a target trajectory for performing driving control and outputs the generated target trajectory to the second controller 160.

In the first situation, the driving control performed by the execution controller 144 includes at least first driving control and second driving control. The first driving control is, for example, driving control in which at least steering of steering and a speed of the host vehicle M is controlled on the basis of the marking lines (for example, marking lines of a part in which the camera marking lines and the map marking lines match (are not separated)) recognized by the first recognizer 132 or the second recognizer 134. For example, the first driving control is driving control in which the host vehicle M is caused to travel such that a representative point of the host vehicle M passes through the center of a lane defined by the marking lines. The second driving control is, for example, driving control in which at least steering of steering and a speed of the host vehicle M is controlled on the basis of the camera marking lines recognized by the first recognizer 132 and traveling position information of another vehicle. For example, the second driving control is driving control in which the host vehicle M is caused to travel such that the representative point of the host vehicle M travels along a trajectory corresponding to the traveling trajectory of the other vehicle m1.

The driving control may include third driving control in which the camera marking lines are preferentially used more than the map marking lines to control at least steering of steering and a speed of the host vehicle M and fourth driving control in which the map marking lines are preferentially used more than the camera marking lines to control at least steering of steering and a speed of the host vehicle M. Preferentially using the camera marking lines more than the map marking lines is, for example, basically performing a process based on the camera marking lines and temporarily switching the process to a process based on the map marking lines, for example, when recognition accuracy of the camera marking lines becomes less than a threshold value or the camera marking lines cannot be recognized. Preferentially using the map marking lines more than the camera marking lines is basically performing a process based on the map marking lines and temporarily switching the process to a process based on the camera marking lines, for example, when the map marking lines cannot be recognized. The third driving control or the fourth driving control is, for example, driving control when the camera marking lines and the map marking lines do not match (are separated).

The driving control may include a plurality of types of driving control with different automation levels (an example of a degree of automation). The automation levels include, for example, a first level, a second level in which the degree of automation of driving control is lower than that of the first level, and a third level in which the degree of automation of driving control is lower than that of the second level. The automation levels may include a fourth level (an example of a fourth degree of control) in which the degree of automation of driving control is lower than that of the third level. Here, an automation level may be a level which is defined by standardized information, regulations, or the like or may be an index value which is set regardless thereof. Accordingly, types, details, and the number of automation levels are not limited to the following example. When it is mentioned that a degree of automation in driving control is low, for example, it means that an automation percentage in driving control is small and a task imposed on a driver is large (heavy). When it is mentioned that automation in driving control is low, it means that a degree of control in which the automated driving control device 100 controls steering or acceleration/deceleration of the host vehicle M is low (a degree of necessity in which a driver needs to intervene in a steering operation or an accelerating/decelerating operation is high). A task imposed on a driver is, for example, surrounding monitoring of the host vehicle M or an operation on the driving operator. The operation on the driving operator includes, for example, a state (hereinafter referred to as a hands-on state) in which the driver grasps the steering wheel. A task imposed on a driver is, for example, a task (a driver task) for an occupant required to maintain automated driving of the host vehicle M. Accordingly, when an imposed task cannot be performed by an occupant, the automation level is lowered. For example, driving control of a first level may include, for example, driving control such as ACC, ALC, LKAS, and TJP. Driving control of a second or third level may include, for example, ACC, ALC, and LKAS. Driving control of a fourth level may include manual driving. In the driving control of the fourth level, for example, driving control such as ACC may be performed. Out of the first to fourth levels, the first level is the highest degree of automation in driving control, and the fourth level is the lowest degree of automation in driving control.

In the first level, there is no task which is imposed on an occupant (the task imposed on an occupant is the lightest). A task which is imposed on an occupant in the second level is, for example, surrounding (particularly, forward) monitoring of the host vehicle M. A task which is imposed on an occupant in the third level includes, for example, a hands-on state in addition to the surrounding monitoring state of the host vehicle M. A task which is imposed on an occupant in the fourth level includes, for example, an operation for controlling steering and a speed of the host vehicle M using the driving operator 80 in addition to the surrounding monitoring state of the host vehicle M and the hands-on state. That is, in the fourth level, driving control can be immediately handed over to manual driving by an occupant, and the task imposed on an occupant is the heaviest. Details of driving control and tasks imposed on an occupant in each automation level are not limited to the aforementioned example. The automated driving control device 100 performs driving control of one of the first to fourth levels on the basis of the surrounding situation of the host vehicle M or a task which is being performed by an occupant.

For example, the execution controller 144 performs first driving control when the determiner 142 determines that the camera marking lines and the map marking lines are not separated and performs second driving control when the determiner 142 determines that the camera marking lines and the map marking lines are separated. The execution controller 144 performs control for ending driving control for the host vehicle M and switching the driving control to manual driving by an occupant or the like.

The execution controller 144 includes, for example, a traveling trajectory estimator 144A and a traveling controller 144B. The traveling controller 144B and the second controller 160 are an example of a “driving controller.” The traveling trajectory estimator 144A estimates a future traveling trajectory of another vehicle m1 which is a neighboring vehicle. For example, when it is determined that the camera marking lines and the map marking lines are separated, the traveling trajectory estimator 144A estimates that the other vehicle m1 moves in an intermediate direction between an extending direction of the other (the map marking lines in the example illustrated in FIG. 3) of the camera marking lines and the map marking lines and a longitudinal direction of a vehicle body of the other vehicle m1 (which may be replaced with a traveling direction of the other vehicle m1 or an extending direction of the traveling trajectory). Specifically, in the example of FIG. 3, the traveling trajectory estimator 144A estimates a future traveling trajectory using a direction A3 between the extending direction A1 of the map marking lines ML1 to ML3 and the longitudinal direction A2 of the vehicle body of the other vehicle m1 as a moving direction of the other vehicle m1.

For example, the traveling trajectory estimator 144A sets the direction A3 to a median position (an intermediate position) between the direction A1 and the direction A2. By setting to the median position, it is possible to continue to perform current driving control without immediately confirming that the camera marking lines or the map marking lines have been erroneously detected. When one thereof is actually erroneous, determination thereof is not too delayed.

The traveling trajectory estimator 144A may set the direction A3 on the basis of an amount of deviation (a degree of separation) between the camera marking lines and the map marking lines. For example, the direction A3 which is biased to the direction A1 side or the direction A2 side according to the amount of deviation in lateral position, the angle formed by the camera marking lines and the map marking lines, and a difference of the change in curvature between the two marking lines is estimated to a direction in which the other vehicle m1 travels. In this way, since the intermediate direction/position is adjusted to a direction/position other than the median position according to the amount of deviation, it is possible to balance continuing to perform control and confirming that the marking lines have been erroneously recognized according to the surrounding situation.

The traveling trajectory estimator 144A calculates a time (time to line crossing (TTLC)) in which the other vehicle m1 departs from one (for example, the camera marking line CL2) of the camera marking line and the map marking line when the other vehicle m1 moves in the estimated moving direction A3. Departing of the other vehicle m1 from the marking line may mean that a reference position (for example, the center, the center of gravity, or an end) of the other vehicle m1 goes over (passes through) the marking line or may mean that the whole part (the whole vehicle body) of the other vehicle m1 goes over the marking line. The lane departure time TTLC is calculated, for example, by dividing a distance to the marking line CL2 by the speed Vm1 of the other vehicle m1.

Instead of (or in addition to) calculating the lane departure time TTLC, when it is determined that the camera marking line and the map marking line are separated, the traveling trajectory estimator 144A may calculate a margin time (time to collision (TTC)) until the other vehicle m1 interferes (collides) with the host vehicle traveling along one (for example, the camera marking line) of the camera marking line and the map marking line when the other vehicle m1 moves in the direction A3. The interference margin time TTC is calculated, for example, by dividing a relative distance between the host vehicle M and the other vehicle m1 by the relative speed between the host vehicle M and the other vehicle m1. In the example illustrated in FIG. 3, the interference margin time TTC when the host vehicle M travels along a lane defined by the camera marking lines CL1 and CL2 and the other vehicle m1 travels in the direction A3 is calculated.

The traveling controller 144B controls traveling of the host vehicle M on the basis of at least one of the lane departure time TTLC and the interference margin time TTC which are calculated by the traveling trajectory estimator 144A. For example, when the lane departure time TTLC is equal to or greater than a threshold value (a TTLC threshold value), the traveling controller 144B generates a target trajectory for continuing to perform traveling control based on one of the camera marking line and the map marking line. The traveling controller 144B may generate a target trajectory for continuing to perform driving control based on one of the camera marking line and the map marking line when the interference margin time TTC is equal to or greater than a threshold value (a TTC threshold value). The traveling controller 144B performs control for curbing (ending or switching the level of) driving control of the host vehicle M when at least one (particularly, the interference margin time TTC) of the lane departure time TTLC and the interference margin time TTC is less than the corresponding threshold value.

For example, when the camera marking line and the map marking line are separated, it is determined that at least one thereof is erroneous. In this case, when correctness is actually determined in a state in which the erroneousness has been confirmed too early, the driving control of the host vehicle M is immediately switched and thus there is a likelihood that the behavior of the host vehicle will be affected. Accordingly, in the first situation, as illustrated in FIG. 3, by not immediately confirming that the other vehicle m1 travels in the direction A1 along the map marking line or in the longitudinal direction A2 of the vehicle body of the other vehicle m1 but estimating that the other vehicle m1 travels in the intermediate direction A3 therebetween, it is possible to increase the lane departure time TTLC and to increase the interference margin time TTC in comparison with a case in which the other vehicle m1 travels in the direction A1 along the map marking line ML2. Accordingly, t it is possible to easily continue to perform current driving control. Thereafter, the traveling controller 144B performs control for switching the driving control or continuing to perform the driving control on the basis of a result of determination of whether the marking lines are separated or a result of comparison between the lane departure time TTLC or the interference margin time TTC and the corresponding threshold value.

The aforementioned control is particularly effective, for example, because the camera marking line and the map marking line are likely to be separated when the host vehicle travels in a lane change section such as a curved road as illustrated in FIG. 4. Accordingly, when the traveling lane of the host vehicle M is a lane change section such as a curved road, the execution controller 144 may perform the aforementioned control. The lane change section includes, for example, a section in which the number of lanes increases or decreases and a section in which a lane shape changes temporarily due to road work or the like in addition to a curved road.

### [Second Situation]

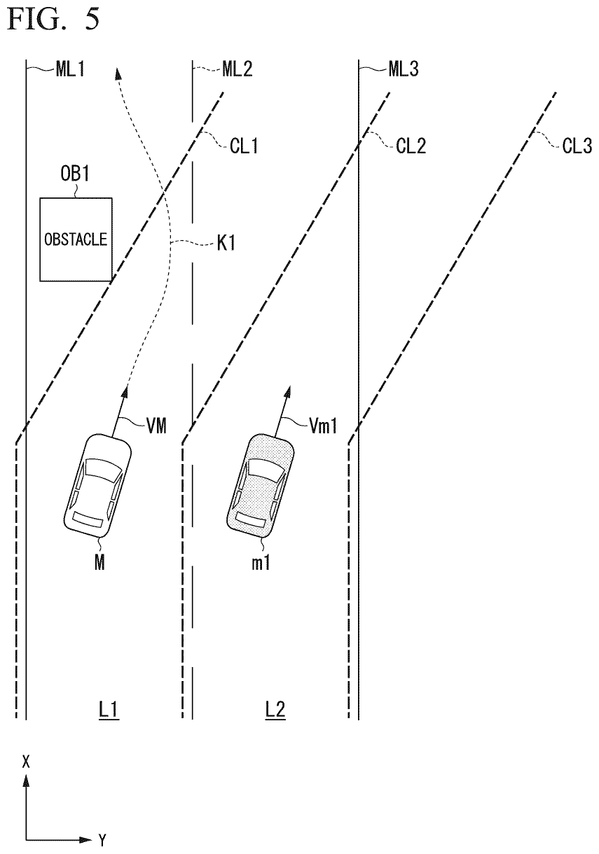

FIG. 5 is a diagram illustrating driving control of the host vehicle M in a second situation. The second situation is different from the first situation in that there is an obstacle OB1 in front of the host vehicle M in the traveling lane L1 (that is, on the scheduled traveling trajectory of the host vehicle M). An obstacle is an object requiring avoiding and overtaking traveling such that a vehicle does not collide therewith, and an example thereof includes a stationary object such as a parked vehicle.

When there is an obstacle OB1 in front of the host vehicle M, the movement schedule generator 140 generates a target trajectory K1 for avoiding collision with the obstacle OB1 as illustrated in FIG. 5. The host vehicle M is caused to travel such that a reference position (for example, the center or the center of gravity) of the host vehicle M moves along the target trajectory K1. In this case, since the direction of the vehicle body of the host vehicle M is tilted with respect to the extending direction of the map marking lines ML1 and ML2 and the camera marking lines also change with the change in direction, the value of the lane departure time TTLC or the interference margin time TTC changes. Accordingly, when there is an obstacle OB1 on the traveling trajectory of the host vehicle M, the determiner 142 determines that one (for example, the camera marking line) of the camera marking line and the map marking line has been erroneously recognized regardless of the value of the lane departure time TTLC or the interference margin time TTC. As a result, when there is an obstacle OB1, it is possible to early determine that the marking line has been erroneously recognized regardless of movement of the other vehicle m1 and to perform driving control based on the determination result.

When it is determined a first predetermined number of times or more that the lane departure time TTLC or the interference margin time TTC is less than the threshold value (a first threshold value), the determiner 142 may determine that one (for example, the camera marking line) of the camera marking line and the map marking line has been erroneously recognized. When the number of times it is determined that the lane departure time TTLC or the interference margin time TTC is less than a second threshold value greater than the corresponding first threshold value is equal to or greater than a second predetermined number of times greater than the first predetermined number of times, the determiner 142 may determine that the other (for example, the map marking line) of the camera marking line and the map marking line has been erroneously recognized. Since erroneous recognition is confirmed with different numbers of samples according to the magnitude of the lane departure time TTLC or the interference margin time TTC, it is possible to curb erroneous determination according to the magnitude of the lane departure time TTLC or the interference margin time TTC and to appropriately perform determination.

Accordingly, it is possible to curb frequent switching of driving control and to further stabilize driving control. When a predetermined time elapses in a state in which it is determined that the camera marking line and the map marking line are separated, the execution controller 144 may end continuing to perform the driving control. Accordingly, it is possible to curb the driving control being maintained for a long time in a state in which the camera marking line and the map marking line are separated. In this case, the traveling controller 144B may switch the driving control to manual driving or may perform control for lowering the automation level of the driving control from the current level. The execution controller 144 may use a condition in which the host vehicle M travels by a predetermined distance or more instead of (or in addition to) the condition in which the predetermined time elapses.

### [Process Flow]

A process flow that is performed by the automated driving control device 100 according to the embodiment will be described below. In the following description, a driving control process based on a recognition situation of a marking line or the like out of processes performed by the automated driving control device 100 will be mainly described below. When the process flow starts, it is assumed that the host vehicle M is performing predetermined driving control. In the following description, several examples will be described. The following processes may be repeatedly performed at predetermined timings or at intervals of a predetermined period or may be repeatedly performed while driving control is being performed by the automated driving control device 100.

### First Example

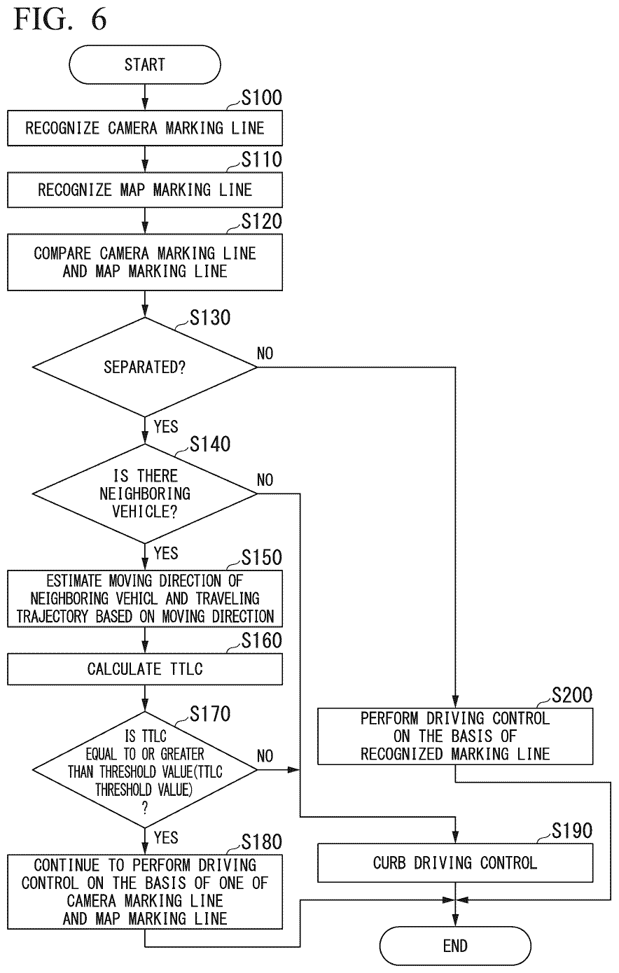

FIG. 6 is a flowchart illustrating an example of a process flow of a driving control process according to a first example. In the example illustrated in FIG. 6, the first recognizer 132 recognizes a marking line (a camera marking line) near the host vehicle M on the basis of an output from the detection device DD detecting the surrounding situation of the host vehicle M (Step S100). Then, the second recognizer 134 recognizes a marking line (a map marking line) near the host vehicle M from map information with reference to the map information on the basis of position information of the host vehicle M (Step S110). Then, the determiner 142 compares the camera marking line with the map marking line (Step S120) and determines whether the camera marking line and the map marking line are separated (Step S130).

When it is determined that the camera marking line and the map marking line are separated, the determiner 142 determines whether a neighboring vehicle (another vehicle) adjacent to the host vehicle M has been detected by the first recognizer 132 (Step S140). When it is determined that there is a neighboring vehicle, the traveling trajectory estimator 144A estimates a moving direction of the neighboring vehicle and a future traveling trajectory of the neighboring vehicle based on the moving direction (Step S150). Then, the traveling trajectory estimator 144A calculates a lane departure time TTLC of the neighboring vehicle on the basis of the future traveling trajectory of the neighboring vehicle (Step S160). Then, the traveling controller 144B determines whether the lane departure time TTLC is equal to or greater than the threshold value (the TTLC threshold value) (Step S170). When it is determined that the lane departure time TTLC is equal to or greater than the threshold value, the traveling controller 144B continues to perform driving control in execution on the basis of one of the camera marking line and the map marking line (Step S180). When the driving control in execution is first driving control or second driving control in the process of Step S180, the traveling controller 144B switches the driving control to third driving control or fourth driving control and continues to perform driving control. One of the camera marking line and the map marking line may be, for example, a predetermined one, one closer to a shape of a past traveling trajectory of the neighboring vehicle, or one in which a degree of change from a nearby road shape is smaller.

When it is determined in the process of Step S170 that the lane departure time TTLC of the neighboring vehicle is not equal to or greater than the threshold value or when it is determined in the process of Step S140 that there is no neighboring vehicle, the traveling controller 144B curbs the driving control (Step S190). “Curbing the driving control” includes, for example, ending the driving control or lowering a current automation level. When it is determined in the process of Step S130 that the camera marking line and the map marking line are not separated, traveling controller 144B performs (continues to perform) the driving control in execution on the basis of the recognized marking lines (the camera marking line and the map marking line) (Step S200). In this way, this routine of the flowchart ends.

### Second Example

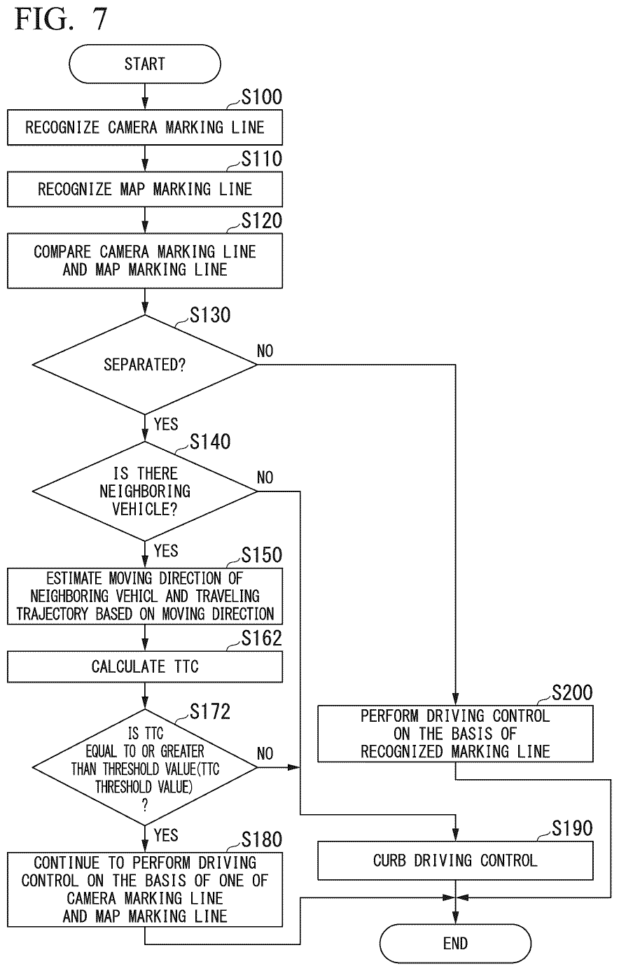

FIG. 7 is a flowchart illustrating an example of a process flow of a driving control process according to a second example. The process flow according to the second example is different from the process flow according to the first example illustrated in FIG. 6, in that the processes of Steps S162 and S172 are provided instead of Steps S160 and S170 out of the processes of Steps S100 to S200. Accordingly, the processes of Steps S162 and S172 will be mainly described below.

In the process of Step S150 illustrated in FIG. 7, after the moving direction of the neighboring vehicle and the traveling trajectory based on the moving direction have been estimated, the traveling trajectory estimator 144A calculates an interference margin time TTC on the basis of the estimated traveling trajectory and the traveling trajectory of the host vehicle M (Step S162). Then, the traveling controller 144B determines whether the calculated interference margin time TTC is equal to or greater than the threshold value (the TTC threshold value) (Step S172). When it is determined that the interference margin time TTC is equal to or greater than the threshold value, the process of Step S180 is performed. When it is determined in the process of Step S172 that the interference margin time TTC is not equal to or greater than the threshold value, the process of Step S190 is performed.

### Modified Examples

In the aforementioned embodiment, when there are a plurality of neighboring vehicles, estimating traveling trajectory of a neighboring vehicle, calculating the lane departure time TTLC or the interference margin time TTC based on the estimated traveling trajectory, or determination or driving control based on the calculation result may be performed using the neighboring vehicle closest to the host vehicle M. When the closest neighboring vehicle is a special vehicle (an emergency vehicle) such as a police vehicle or a firefighting vehicle, the neighboring vehicle may perform behavior different from those of normal vehicles (regular vehicles) and thus may be excluded from candidates for the neighboring vehicle.

In the embodiment, both the lane departure time TTLC and the interference margin time TTC may be calculated, the calculation results may be compared with the corresponding threshold values, and driving control may continue to be performed on the basis of one of the camera marking line and the map marking line when both are equal to or greater than the corresponding threshold values. Accordingly, it is possible to perform more safe driving control.

The execution controller 144 may select and use one of the lane departure time TTLC and the interference margin time TTC for determination according to a surrounding situation such as a road shape or a nearby vehicle. Accordingly, it is possible to realize appropriate traveling control according to the surrounding situation.

In the embodiment, it may be determined whether the camera marking line and the map marking line match instead of determining whether the camera marking line and the map marking line are separated. In the embodiment, when it is determined that the camera marking line and the map marking line are separated, one of the camera marking line and the map marking line is the camera marking line and the other thereof is the map marking line, but the camera marking line and the map marking line may be reversed.

According to the aforementioned embodiment, the automated driving control device 100 (an example of a vehicle control device) includes: the first recognizer 132 configured to recognize a camera marking line (an example of a first marking line) defining a traveling lane of a host vehicle M and a surrounding situation including a neighboring vehicle traveling in a neighboring lane which is adjacent to the traveling lane of the host vehicle M on the basis of an output of the detection device DD detecting the surrounding situation of the host vehicle M; the second recognizer 134 configured to recognize a map marking line (an example of a second marking line) defining a lane near the host vehicle M from the map information on the basis of position information of the host vehicle M; the driving controller configured to perform driving control for controlling at least steering of steering and the speed of the host vehicle M on the basis of recognition results from the first recognizer 132 and the second recognizer 134; and the traveling trajectory estimator 144A configured to estimate a traveling trajectory of the neighboring vehicle. The driving controller performs the driving control on the basis of one of the camera marking line and the map marking line when the camera marking line recognized by the first recognizer 132 is separated from the map marking line, the traveling trajectory estimator 144A estimates an intermediate direction between the extending direction of the other of the camera marking line and the map marking line and the longitudinal direction of the vehicle body of the neighboring vehicle as a moving direction of the neighboring vehicle when the camera marking line and the map marking line are separated, and calculates a time which the neighboring vehicle will take to depart from one of the camera marking line and the map marking line when the neighboring vehicle moves in the estimated moving direction, and the driving controller continues to perform the driving control when the time is equal to or greater than a threshold value. Accordingly, it is possible to perform more appropriate driving control according to road marking lines near a vehicle and situations of other vehicles. In addition, it is possible to contribute to advancement of a sustainable transportation system.

In the automated driving control device 100 (an example of the vehicle control device) according to the aforementioned embodiment, the traveling trajectory estimator 144A estimates an intermediate direction between the extending direction of the other of the camera marking line and the map marking line and the longitudinal direction of the vehicle body of the neighboring vehicle as a moving direction of the neighboring vehicle when the camera marking line and the map marking line are separated, and calculates a time which the host vehicle traveling under the driving control and the neighboring vehicle will take to interfere with each other when the neighboring vehicle moves in the estimated moving direction, and the driving controller continues to perform the driving control when the time is equal to or greater than a threshold value. Accordingly, it is possible to perform more appropriate driving control according to road marking lines near a vehicle and situations of other vehicles. In addition, it is possible to contribute to advancement of a sustainable transportation system.

According to the embodiment, when the camera marking line and the map marking line are separated, it is possible to perform more appropriate driving control, for example, by appropriately predicting interference in the future between the host vehicle M and a neighboring vehicle (for example, another vehicle traveling in a neighboring lane) on the basis of the other vehicle and a lane shape. According to the embodiment, when the camera marking line and the map marking line are separated, a future traveling trajectory of the neighboring vehicle can be estimated from the extending direction of one marking line thereof and the direction of the neighboring vehicle, and control (including avoidance control for avoiding interference with another vehicle) for continuously performing the driving control which is being performed by the host vehicle M can be performed on the basis of the estimated trajectory.

Since the camera marking line and the map marking line are separated, it is determined that the marking line serving as a base for the host vehicle M to perform driving control is erroneous when the lane departure time TTLC or the interference margin time TTC is less than the corresponding threshold value while the host vehicle M is traveling along one marking line. In this case, when correctness is actually determined in a state in which the erroneousness has been confirmed too early, the driving control is immediately switched and thus the behavior of the host vehicle M is affected. Accordingly, according to the embodiment, it is possible to curb the driving control being immediately switched by estimating the direction (traveling direction) of the neighboring vehicle such that the lane departure time TTLC or the interference margin time TTC increases on the basis of the extending direction of the marking line and the longitudinal direction of the vehicle body of the neighboring vehicle and continuously performing the driving control which is being performed by the host vehicle M.

According to the embodiment, it is possible to perform (maintain) driving control using more appropriate information in a lane changing section such as a curved road in which the camera marking line and the map marking line are likely to be separated.

The above-mentioned embodiment can be expressed as follows:

A vehicle control device including:
a storage medium configured to store computer-readable instructions; and
a processor connected to the storage medium,
wherein the processor executes the computer-readable instructions to perform:
   recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
   recognizing a second marking line defining a lane near the host vehicle from map information on the basis of position information of the host vehicle;
   performing driving control for controlling at least steering of steering and a speed of the host vehicle on the basis of recognition results;
   estimating a traveling trajectory of the neighboring vehicle;
   performing the driving control on the basis of one of the first marking line and the second marking line when the first marking line and the second marking line are separated;
   estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
   calculating a time which the neighboring vehicle is to take to depart from one of the first marking line and the second marking line when the neighboring vehicle moves in the estimated moving direction; and
   continuing to perform the driving control when the time is equal to or greater than a threshold value.

The above-mentioned embodiment can also be expressed as follows:

A vehicle control device including:
a storage medium configured to store computer-readable instructions; and
a processor connected to the storage medium,
wherein the processor executes the computer-readable instructions to perform:
   recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
   recognizing a second marking line defining a lane near the host vehicle from map information on the basis of position information of the host vehicle;
   performing driving control for controlling at least steering of steering and a speed of the host vehicle on the basis of recognition results;
   estimating a traveling trajectory of the neighboring vehicle;
   performing the driving control on the basis of one of the first marking line and the second marking line when the first marking line and the second marking line are separated;
   estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
   calculating a time which the host vehicle traveling under the driving control and the neighboring vehicle are to take to interfere with each other when the neighboring vehicle moves in the estimated moving direction; and
   continuing to perform the driving control when the time is equal to or greater than a threshold value.

While an embodiment of the present invention has been described above, the present invention is not limited to the embodiment and can have various modifications and substitutions applied thereto without departing from the gist of the present invention.

What is claimed is:

1. A vehicle control device comprising:
a first recognizer configured to recognize a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
a second recognizer configured to recognize a second marking line defining a lane near the host vehicle from map information on the basis of position information of the host vehicle;
a driving controller configured to perform driving control for controlling at least steering of steering and a speed of the host vehicle on the basis of recognition results from the first recognizer and the second recognizer; and
a traveling trajectory estimator configured to estimate a traveling trajectory of the neighboring vehicle,
wherein the driving controller performs the driving control on the basis of one of the first marking line and the second marking line when the first marking line and the second marking line are separated,
wherein the traveling trajectory estimator estimates an intermediate direction between an extending direction of the other of the first marking line and the second marking line and a longitudinal direction of a vehicle body of the neighboring vehicle as a moving direction of the neighboring vehicle when the first marking line and the second marking line are separated,
wherein the traveling trajectory estimator calculates a time which the neighboring vehicle is to take to depart from one of the first marking line and the second marking line when the neighboring vehicle moves in the estimated moving direction, and
wherein the driving controller continues to perform the driving control when the time is equal to or greater than a threshold value.

2. A vehicle control device comprising:
a first recognizer configured to recognize a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
a second recognizer configured to recognize a second marking line defining a lane near the host vehicle from map information on the basis of position information of the host vehicle;
a driving controller configured to perform driving control for controlling at least steering of steering and a speed of the host vehicle on the basis of recognition results from the first recognizer and the second recognizer; and
a traveling trajectory estimator configured to estimate a traveling trajectory of the neighboring vehicle,
wherein the driving controller performs the driving control on the basis of one of the first marking line and the second marking line when the first marking line and the second marking line are separated,
wherein the traveling trajectory estimator estimates an intermediate direction between an extending direction of the other of the first marking line and the second marking line and a longitudinal direction of a vehicle body of the neighboring vehicle as a moving direction of the neighboring vehicle when the first marking line and the second marking line are separated,
wherein the traveling trajectory estimator calculates a time which the host vehicle traveling under the driving control and the neighboring vehicle are to take to interfere with each other when the neighboring vehicle moves in the estimated moving direction, and
wherein the driving controller continues to perform the driving control when the time is equal to or greater than a threshold value.

3. The vehicle control device according to claim 1, further comprising a determiner configured to determine that one of the first marking line and the second marking line has been erroneously recognized when an obstacle is present in the traveling lane of the host vehicle.

4. The vehicle control device according to claim 1, further comprising a determiner configured to determine that one of the first marking line and the second marking line has been erroneously recognized when it is determined a first predetermined number of times or more that the time is less than a first threshold value and to determine that the other of the first marking line and the second marking line has been erroneously recognized when the number of times the time is less than a second threshold value greater than the first threshold value is equal to or greater than a second predetermined number of times larger than the first predetermined number of times.

5. The vehicle control device according to claim 1, wherein the traveling trajectory estimator estimates an intermediate position between the extending direction of the other of the first marking line and the second marking line and the longitudinal direction of the vehicle body of the neighboring vehicle as a traveling direction of the neighboring vehicle.

6. The vehicle control device according to claim 1, wherein the traveling trajectory estimator adjusts the intermediate direction according to an amount of deviation between the first marking line and the second marking line when the neighboring vehicle is estimated to be traveling in the intermediate direction between the extending direction of the other of the first marking line and the second marking line and the longitudinal direction of the vehicle body of the neighboring vehicle.

7. The vehicle control device according to claim 1, further comprising a determiner configured to determine whether the first marking line has been erroneously recognized on the basis of at least one of a change in curvature of the first marking line and an angle formed by the first marking line and the second marking line when it is determined whether the first marking line and the second marking line are separated and to perform the determination of erroneous recognition when a changing direction of the change in curvature and a changing direction of the angle are the same and the change in curvature and the angle increase according to a distance from the host vehicle.

8. A vehicle control method that is performed by a computer, the vehicle control method comprising:
recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
recognizing a second marking line defining a lane near the host vehicle from map information on the basis of position information of the host vehicle;
performing driving control for controlling at least steering of steering and a speed of the host vehicle on the basis of recognition results;
estimating a traveling trajectory of the neighboring vehicle;
performing the driving control on the basis of one of the first marking line and the second marking line when the first marking line and the second marking line are separated;
estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
calculating a time which the neighboring vehicle is to take to depart from one of the first marking line and the second marking line when the neighboring vehicle moves in the estimated moving direction; and
continuing to perform the driving control when the time is equal to or greater than a threshold value.

9. A vehicle control method that is performed by a computer, the vehicle control method comprising:
recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
recognizing a second marking line defining a lane near the host vehicle from map information on the basis of position information of the host vehicle;
performing driving control for controlling at least steering of steering and a speed of the host vehicle on the basis of recognition results;
estimating a traveling trajectory of the neighboring vehicle;
performing the driving control on the basis of one of the first marking line and the second marking line when the first marking line and the second marking line are separated;
estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
calculating a time which the host vehicle traveling under the driving control and the neighboring vehicle are to take to interfere with each other when the neighboring vehicle moves in the estimated moving direction; and
continuing to perform the driving control when the time is equal to or greater than a threshold value.

10. A non-transitory computer-readable storage medium storing a program, the program causing a computer to perform:
recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
recognizing a second marking line defining a lane near the host vehicle from map information on the basis of position information of the host vehicle;
performing driving control for controlling at least steering of steering and a speed of the host vehicle on the basis of recognition results;
estimating a traveling trajectory of the neighboring vehicle;
performing the driving control on the basis of one of the first marking line and the second marking line when the first marking line and the second marking line are separated;
estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
calculating a time which the neighboring vehicle is take to depart from one of the first marking line and the second marking line when the neighboring vehicle moves in the estimated moving direction; and
continuing to perform the driving control when the time is equal to or greater than a threshold value.

11. A non-transitory computer-readable storage medium storing a program, the program causing a computer to perform:
recognizing a first marking line defining a traveling lane of a host vehicle and a surrounding situation including a neighboring vehicle traveling in a neighboring lane which is adjacent to the traveling lane of the host vehicle on the basis of an output of a detection device detecting the surrounding situation of the host vehicle;
recognizing a second marking line defining a lane near the host vehicle from map information on the basis of position information of the host vehicle;
performing driving control for controlling at least steering of steering and a speed of the host vehicle on the basis of recognition results;
estimating a traveling trajectory of the neighboring vehicle;
performing the driving control on the basis of one of the first marking line and the second marking line when the first marking line and the second marking line are separated;
estimating an intermediate direction between an extending direction of the other of the first marking line and the second marking line and a longitudinal direction of a vehicle body of the neighboring vehicle as a moving direction of the neighboring vehicle when the first marking line and the second marking line are separated;
calculating a time which the host vehicle traveling under the driving control and the neighboring vehicle are to take to interfere with each other when the neighboring vehicle moves in the estimated moving direction; and
continuing to perform the driving control when the time is equal to or greater than a threshold value.
